(19) United States
(12) Patent Application Publication
(10) Pub. No.: US 2026/0094398 A1
(43) Pub. Date: Apr. 2, 2026

(54) VEHICLE CONTROL APPARATUS

(71) Applicant: Honda Motor Co., Ltd., Tokyo (JP)

(72) Inventors: Yoshimitsu Murahashi, Tokyo (JP); Shota Ishikawa, Tokyo (JP)

(21) Appl. No.: 19/343,452

(22) Filed: Sep. 29, 2025

(30) Foreign Application Priority Data
Oct. 2, 2024 (JP) 2024-172997

(51) Int. Cl. G06V 10/10; B60W 10/20; B60W 30/14; B60W 50/00; G06V 10/26; G06V 20/56

(52) U.S. Cl. CPC G06V 10/16; B60W 10/20; B60W 30/143; B60W 50/0097; G06V 10/26; G06V 20/588; B60W 2050/0083; B60W 2420/403; B60W 2540/18; B60W 2552/30; B60W 2552/53; B60W 2556/10

(57) ABSTRACT

A vehicle control apparatus includes a sensor configured to acquire exterior environment information around a subject vehicle, including a driving path, as a camera image, a driving actuator, and a microprocessor. The microprocessor classifies a region of the image into a drivable region and a non-drivable region by predetermined segmentation processing, calculates a virtual curvature as an estimated value of curvature of the driving path based on a driving state including a steering angle of the subject vehicle, and calculates a virtual future path serving as an estimated value of a future path of the subject vehicle in a bird's-eye view coordinate system based on the virtual curvature. The microprocessor then determines whether the virtual future path is included in the drivable region, sets the virtual future path as the future path of the subject vehicle, and performs driving control based on the set future path.

### CROSS-REFERENCE TO RELATED APPLICATION

This application is based upon and claims the benefit of priority from Japanese Patent Application No. 2024-172997 filed on Oct. 2, 2024, the content of which is incorporated herein by reference.

### BACKGROUND OF THE INVENTION

### Field of the Invention

The present invention relates to a vehicle control apparatus for displaying information for driving assistance.

### Description of the Related Art

As this type of technique, a technique is known in which a road shape within a first distance is estimated as a curve having a constant curvature change rate, and a road shape beyond the first distance is estimated as a curve having a constant curvature (see Japanese Patent No. 6285321).

In the conventional technique, since a distant road shape is estimated on the assumption that the curvature beyond the first distance is constant, it is difficult to apply the conventional technique to a complicated road shape having a non-constant curvature such as a general road.

Since the curvature of the road is required to generate the path of the driving vehicle, appropriately estimating the curvature contributes to appropriate vehicle control regarding, for example, the driving speed, the steering angle, and the like. That is, it is possible to suppress a decrease in smoothness of traffic while improving safety of traffic.

### SUMMARY OF THE INVENTION

An aspect of the present invention is a vehicle control apparatus including: an exterior environment information acquisition sensor configured to acquire exterior environment information around a subject vehicle including a driving path as an image; a actuator for driving; and a microprocessor. The microprocessor is configured to perform: classifying a region of the image into a drivable region and a non-drivable region by predetermined segmentation processing; calculating a virtual curvature as an estimated value of curvature of the driving path based on a driving state including a steering angle of the subject vehicle; calculating, based on the virtual curvature, a virtual future path serving as an estimated value of a future path of the subject vehicle in a bird's-eye view coordinate system; comparing the exterior environment information with the virtual future path and determining whether or not the virtual future path is included in the drivable region; setting the virtual future path as the future path of the subject vehicle based on a determination result; and executing driving control by outputting instruction information to the actuator such that the subject vehicle travels along the future path. The microprocessor is configured to perform the determining including determining by converting the virtual future path from the bird's-eye view coordinate system to a perspective view coordinate system of the exterior environment information and superimposing the virtual future path on the exterior environment information to determine whether or not the virtual future path is included in the drivable region.

### BRIEF DESCRIPTION OF THE DRAWINGS

The objects, features, and advantages of the present invention will become clearer from the following description of embodiments in relation to the attached drawings, in which:

FIG. 1 is a block diagram illustrating an overall configuration of a vehicle control apparatus according to the embodiment of the present invention;

FIG. 2 is a block diagram illustrating a configuration of a speed control apparatus according to the embodiment;

FIG. 3 is a block diagram describing a main part of the speed control apparatus;

FIG. 4A is a schematic diagram illustrating a flow of processing for searching a curvature of a driving path;

FIG. 4B is a schematic diagram illustrating updating of the curvature;

FIG. 4C is a schematic diagram exemplifying a relationship among a virtual curvature, a curvature radius, and a position before and after updating;

FIG. 4D is a schematic diagram illustrating the virtual curvature;

FIG. 5A is a flowchart illustrating an example of arithmetic processing executed by an arithmetic unit based on a program; and

FIG. 5B is a flowchart illustrating an example of a pre-determination processing.

### DETAILED DESCRIPTION OF THE INVENTION

An embodiment of the invention will be described below with reference to the drawings.

A speed control apparatus serving as an example of a vehicle control apparatus according to an embodiment of the present invention controls a driving speed of a vehicle such that acceleration in a front-back direction and a lateral direction equal to or greater than predetermined prescribed values is not generated when the vehicle drives following a target route (may be referred to as a target path) on a driving path. In addition, the steering angle by a steering device (e.g., a power steering device) may be controlled such that a driving position of the vehicle follows the target path. The speed control apparatus can be applied to, for example, a vehicle having a self-driving capability, that is, a self-driving vehicle.

Note that a speed control apparatus according to the embodiment can be applied to both a manual driving vehicle having a driving assistance capability and a self-driving vehicle, but for the sake of convenience of description, a case where the speed control apparatus is applied to a self-driving vehicle will be described below as an example.

Furthermore, in the embodiment, a vehicle on which the speed control apparatus is mounted may be referred to as a subject vehicle to be distinguished from other vehicles. The subject vehicle may be any of an engine vehicle having an internal combustion engine (engine) as a driving drive source, an electric vehicle having a driving motor as a driving drive source, and a hybrid vehicle having an engine and a driving motor as a driving drive source. The subject vehicle is capable of driving not only in a self-drive mode that does not require a driving operation by a driver but also in a manual drive mode that requires a driving operation by a driver.

### <Configuration of Vehicle>

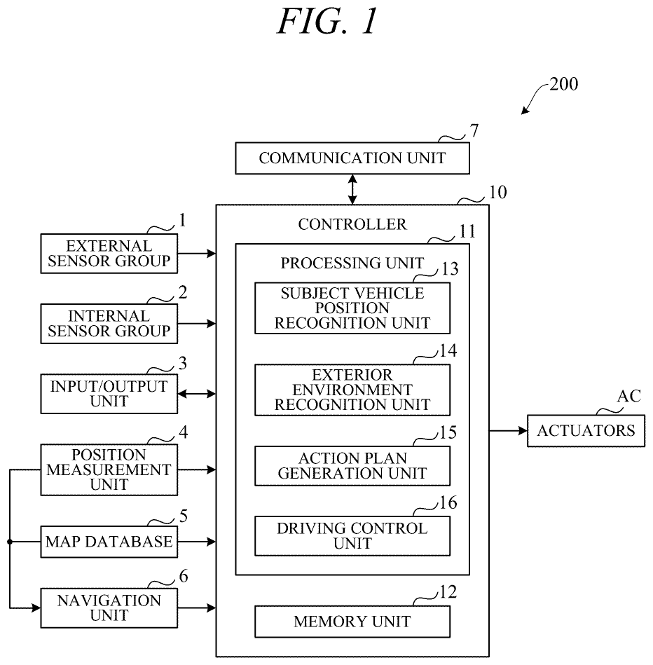

First, a schematic configuration of a vehicle related to self-driving will be described. FIG. 1 is a block diagram illustrating an overall configuration of a vehicle control apparatus 200 of a subject vehicle including the speed control apparatus according to the present embodiment. As illustrated in FIG. 1, the vehicle control apparatus 200 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures scattered light with respect to irradiation light in all directions of the subject vehicle and measures the distance from the subject vehicle to surrounding obstacles, a radar that detects other vehicles, obstacles, and the like around the subject vehicle by irradiating electromagnetic waves and detecting reflected waves, and a camera that is installed in the subject vehicle, has an imaging element (image sensor) such as a charge coupled device (CCD) or a complementary metal oxide semiconductor (CMOS) sensor, and captures images of the surrounding (front, rear, and side) of the subject vehicle.

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction (advancing direction) of the subject vehicle and an acceleration in a lateral direction (lane width direction) of the subject vehicle, a revolution sensor that detects the number of revolutions of the traveling drive source, and a yaw rate sensor that detects a rotation angular speed around a vertical axis of the center of gravity of the subject vehicle. The internal sensor group 2 also includes sensors that detect a driver's driving operation such as an operation on an accelerator pedal, an operation on a brake pedal, or an operation on a steering wheel in the manual drive mode.

Input/output device 3 is a generic term for devices to and from which a command is input by a driver or information is output to the driver. For example, the input/output device 3 includes various switches to which a driver inputs various commands by operating an operation member, a microphone to which the driver inputs commands with voice, a display that provides information to the driver via a display image, a speaker that provides information to the driver with voice, and the like.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and is constituted of, for example, a magnetic disk or a semiconductor element. The map information may include road position information, information on a road shape (curvature or the like), and position information on intersections and branch points. Note that the map information stored in the map database 5 is different from highly accurate map information stored in a memory unit 12 of the controller 10.

The navigation unit 6 is a device that searches for a route on roads to a destination that has been input, for example, by a driver and that performs traveling guidance along the searched route. The entry of the destination and the traveling guidance along the searched route are performed via the input/output device 3. The route search is calculated on the basis of a current position of the subject vehicle measured by the position measurement unit 4, the destination entered by the driver, and the map information stored in the map database 5. The current position of the subject vehicle can be measured using the detection values of the external sensor group 1, and the route may be searched on the basis of the current position and the highly accurate map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuators AC also include a brake actuator that operates a braking device of the subject vehicle and an actuator that drives a steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface.

Note that although a plurality of ECUs having different functions such as an engine control ECU, a driving motor control ECU, and a braking device ECU can be separately provided, in FIG. 1, the controller 10 is illustrated as a set of these ECUs for convenience.

The memory unit 12 stores highly accurate detailed map information for self-driving. The high-precision map information includes position information of a road, information on a road shape (curvature radius etc.), information on gradient of a road, position information of intersections and junctions, types and position information of division lines such as white lines, information on number of lanes (driving lanes), lane width and position information of each lane (information on center position of lanes and boundaries of lane positions), position information of landmarks (traffic lights, signs, buildings etc.) serving as marks on the map, and information on road surface profiles such as road surface irregularities. The high-precision map information stored in the memory unit 12 may include high-precision map information acquired from the outside of the subject vehicle via the communication unit 7, or may include high-precision map information created by the subject vehicle itself using detection values of an external sensor group 1 or detection values of the external sensor group 1 and an internal sensor group 2. The memory unit 12 may store programs for various types of control and information such as threshold values used in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (subject vehicle position) on the map, based on the position information for the subject vehicle that has been obtained by the position measurement unit 4 and the map information in the map database 5. The subject vehicle position may be recognized using the high-precision map information stored in the memory unit 12 and surrounding information of the subject vehicle that has been detected by the external sensor group 1, and thus it becomes possible to recognize the subject vehicle position with high accuracy. The movement information (a moving direction and a moving distance) of the subject vehicle may be calculated based on the detection values of the internal sensor group 2, and the position of the subject vehicle can also be recognized.

Note that in a case where the subject vehicle position can be measured by a sensor installed on a road or outside a road side, the subject vehicle position can also be recognized by communicating with the sensor via the communication unit 7.

The exterior environment recognition unit 14 recognizes an external situation of the periphery of the subject vehicle, based on a signal from the external sensor group 1 such as a camera, a LiDAR, and a radar. For example, a position, a speed, and an acceleration of a surrounding vehicle (a forward vehicle or a rearward vehicle) driving around the subject vehicle, a position of a surrounding vehicle stopped or parked at the periphery of the subject vehicle, and a position and a state of another object are recognized, and target information is created. Note that, in the embodiment, the external situation of the periphery of the subject vehicle merely needs to be recognized based on at least a signal from the camera.

The other objects include a sign, a traffic light, a road, a building, a guardrail, a utility pole, a signboard, a pedestrian, a bicycle, and the like. Indications such as division lines (white lines, etc.) and stop lines on a road surface are also included in the other objects (roads). The states of other objects include a color (red, green, yellow) of a traffic light, and the moving speed and direction of a pedestrian or a bicycle. A part of a stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current time point to a predetermined time ahead based on, for example, a route searched by the navigation unit 6, the high-precision map information stored in the memory unit 12, the subject vehicle position recognized by the subject vehicle position recognition unit 13, and the external situation recognized by the exterior environment recognition unit 14. When a plurality of paths can be present as candidates of the target path on the route searched by the navigation unit 6, the action plan generation unit 15 selects, from among the plurality of paths, an optimal path that satisfies criteria such as compliance with laws and regulations and efficient and safe driving, and generates the selected path as the target route.

Then, the action plan generation unit 15 generates an action plan corresponding to the generated target route. The action plan generation unit 15 generates various action plans corresponding to driving modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. When generating a target route, the action plan generation unit 15 first determines a driving mode and generates a target route based on the driving mode (also referred to as a path plan). Then, a steering angle is determined (which may be referred to as a steering angle plan) and a driving speed is determined (which may be referred to as a speed plan) so as to follow the target route and so as not to generate acceleration in the lateral direction (which may be referred to as an allowable acceleration) equal to or greater than a prescribed value.

In the self-drive mode, the driving control unit 16 controls each actuator AC such that the subject vehicle drives along the target route generated by the action plan generation unit 15. For example, the driving control unit 16 calculates a required driving force for realizing the speed plan (e.g., the target acceleration per unit time) calculated by the action plan generation unit 15 in consideration of the driving resistance determined by the road gradient or the like in the self-drive mode. Then, for example, the actuator AC is feedback-controlled so that actual acceleration that has been detected by the internal sensor group 2 becomes the target acceleration. That is, the driving actuator AC is controlled such that the subject vehicle drives at the target vehicle speed and the target acceleration.

In addition, the driving control unit 16 controls the steering actuator AC by outputting a steering angle instruction signal for realizing the steering angle plan (optimal steering angle for causing the subject vehicle to drive while following the target route) calculated by the action plan generation unit 15 based on the vehicle state quantity and the like observed by the internal sensor group 2 and the like in the self-drive mode.

Note that in the manual drive mode, the driving control unit 16 controls each of the actuators AC in accordance with a drive command (steering operation etc.) from the driver acquired by the internal sensor group 2.

### <Estimation of Curvature Radius>

By the way, for example, in a case where the subject vehicle drives on a road that is not stored as the high-precision map information in the memory unit 12 for the first time, or in a case where the position of the driving lane is temporarily changed due to construction or the like and the shape of the road on which the subject vehicle drives is different from the high-precision map information, the subject vehicle cannot refer to the existing high-precision map information.

In the embodiment, when the vehicle drives on such a road, the actual shape of the road, specifically, the curvature radius of the road is estimated based on the camera image acquired by the camera serving as the external sensor group 1. By appropriately estimating the curvature radius of the road, it is possible to drive along a target route, lane keep driving (keep lanes), or drive within a predetermined lateral acceleration for a road not included in the high-precision map information.

Note that the reciprocal of the curvature radius is curvature. Therefore, the curvature of the road may be estimated based on the actual shape of the road. In the following description, a case where the curvature of the road is estimated based on the actual shape of the road will be described as an example. In addition, in the following description, a road on which the subject vehicle drives may be referred to as a driving path.

As a feature of a camera image (perspective view) acquired by a general camera, a subject farther away from the camera (a road surface of a driving path in the embodiment) appears smaller (in other words, as the distance from the subject vehicle increases, the number of pixels constituting the road surface in the camera image decreases), so that resolution of a distant road surface portion is reduced. This makes it difficult to correctly estimate the curvature of the distant driving path based on the camera image. It is particularly difficult to estimate the curvature of a driving path having a non-constant curvature.

Therefore, in the embodiment, the shape of the road surface is represented as a bird's-eye view of the driving path viewed from above, a driving path (referred to as a virtual future path) of the subject vehicle is calculated in the bird's-eye view in accordance with the curvature of the driving path estimated in the bird's-eye view, the virtual future path is coordinate-converted from the bird's-eye view coordinate system to the perspective view coordinate system, and then the virtual future path after the coordinate-conversion is superimposed on the camera image.

Specifically, the estimation (update) of the curvature of the driving path, the calculation of the virtual future path of the subject vehicle corresponding to the updated curvature in the bird's-eye view coordinates, and the coordinate conversion of the virtual future path calculated in the bird's-eye view coordinates to be superimposed on the camera image indicated by the perspective view coordinates are repeated until the virtual future path after the coordinate conversion falls within the region (referred to as a drivable region) of the road surface in the camera image.

In the embodiment, the processing of repeating the estimation (update) of the curvature, the calculation of the virtual future path, and the superimposition on the camera image is referred to as search. Note that, in order to distinguish the search for a route by the navigation unit 6, the search may be referred to as a curvature search. The speed control apparatus according to the embodiment searches for the curvature to match the driving track in the camera image with the drivable region while assuming a realistic driving track, thereby appropriately estimating the curvature necessary for the speed plan. By appropriately estimating the curvature even for a driving path having a non-constant curvature, the driving control of the subject vehicle based on the estimated curvature can be appropriately performed. The configuration of such a speed control apparatus will be described in more detail.

### <Speed Control Apparatus>

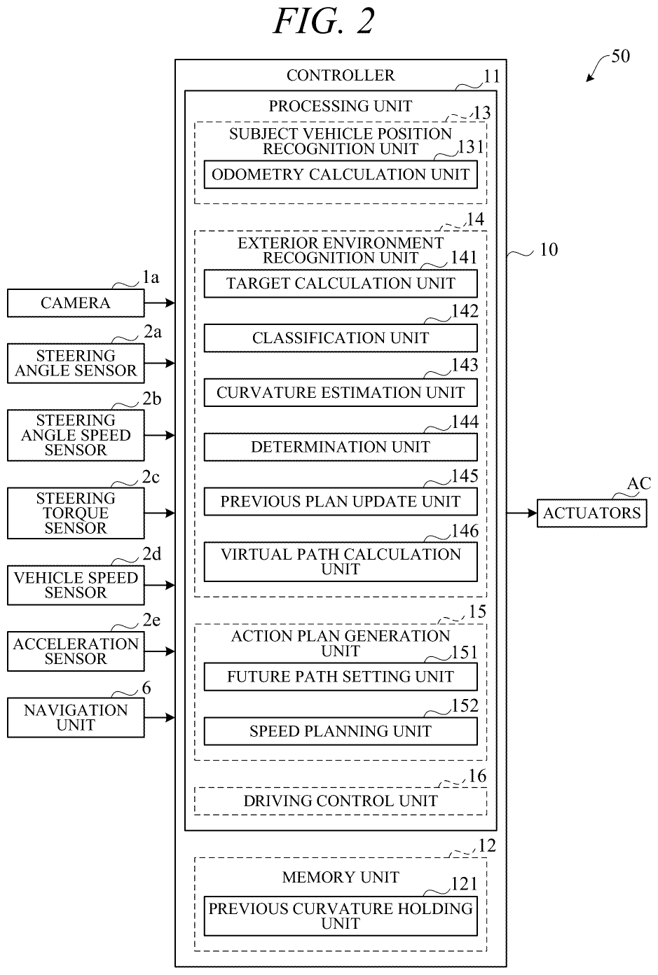

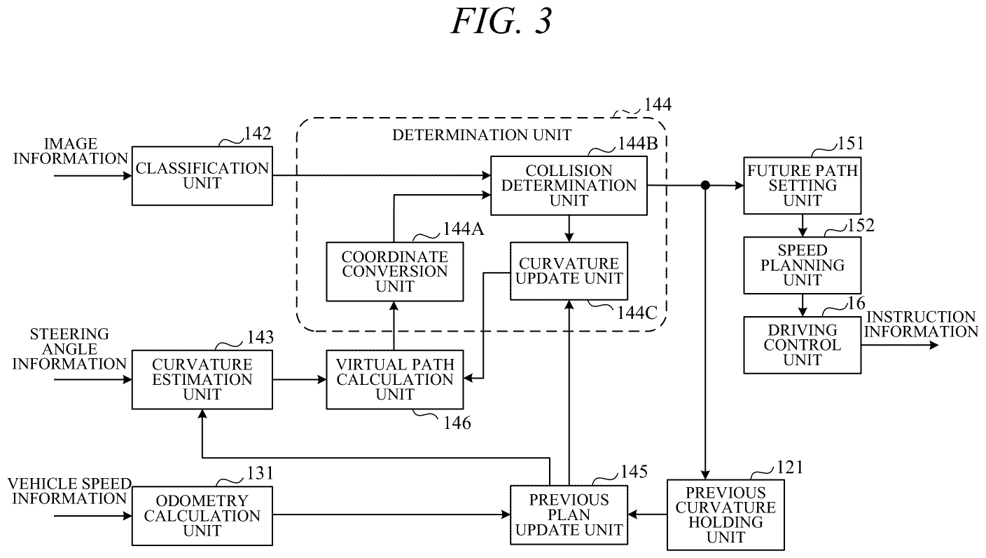

FIG. 2 is a block diagram illustrating a configuration of a speed control apparatus 50 according to the embodiment. FIG. 3 is a block diagram describing a main part of the speed control apparatus. As an example, the speed control apparatus 50 is configured as a part of the function of the controller 10 in FIG. 1 and plays a part of the function of the vehicle control apparatus 200. A camera 1a, a steering angle sensor 2a, a steering angle speed sensor 2b, a steering torque sensor 2c, a vehicle speed sensor 2d, an acceleration sensor 2e, a navigation unit 6, and an actuator AC are connected to the controller 10.

The camera 1a is a monocular camera having an imaging element, and constitutes a part of the external sensor group 1 in FIG. 1. The camera 1a is attached at a predetermined position, for example, in a front part of the subject vehicle, and continuously images a space on a front side of the subject vehicle at a predetermined framerate (e.g., 10 frames/seconds) to acquire an image (camera image) of an object. The object includes a division line or the like that defines a lane on a road. Note that the object may be detected by a radar, a LiDAR, or the like together with the camera 1a.

The steering angle sensor 2a detects, for example, a rotation angle (steering angle) of a steering shaft coupled to a steering wheel (not illustrated). The steering angle speed sensor 2b detects a rotation angle speed (also referred to as a steering angle speed) of the steering shaft. The steering angle speed may be simply referred to as a steering angle speed. The steering torque sensor 2c detects a steering operation by the driver, more specifically, steering torque that acts on the steering wheel. For example, the steering angle detected by the steering angle sensor 2a when the steering wheel is rotated leftward (counterclockwise) from the neutral position is set to a positive value, and the steering angle detected by the steering angle sensor 2a when the steering wheel is rotated rightward (clockwise) from the neutral position is set to a negative value.

The steering angle sensor 2a, the steering angle speed sensor 2b, and the steering torque sensor 2c constitute a part of the internal sensor group 2 of FIG. 1.

The vehicle speed sensor 2d detects the vehicle speed of the subject vehicle. The acceleration sensor 2e detects acceleration in the front-back direction and the lateral direction of the subject vehicle. The vehicle speed sensor 2d and the acceleration sensor 2e also constitute a part of the internal sensor group 2 of FIG. 1.

Note that an Inertial Measurement Unit (IMU) that detects translational motion and rotational motion in three axial directions of the subject vehicle may be provided as one of the internal sensor groups 2.

The controller 10 includes an odometry calculation unit 131, a target calculation unit 141, a classification unit 142, a curvature estimation unit 143, a determination unit 144, a previous plan update unit 145, a virtual path calculation unit 146, a future path setting unit 151, and a speed planning unit 152 as a functional configuration which the processing unit 11 (FIG. 1) is responsible for. Furthermore, as described above, the controller 10 includes the memory unit 12.

Note that the odometry calculation unit 131 may constitute a part of the subject vehicle position recognition unit 13. The target calculation unit 141, the classification unit 142, the curvature estimation unit 143, the determination unit 144, the previous plan update unit 145, and the virtual path calculation unit 146 may constitute a part of the exterior environment recognition unit 14. The future path setting unit 151 and the speed planning unit 152 may constitute a part of the action plan generation unit 15. The previous curvature holding unit 121 may constitute a part of the memory unit 12.

### <Movement Amount>

The odometry calculation unit 131 calculates the movement amount of the subject vehicle based on the vehicle speed information detected by the vehicle speed sensor 2d, the rotation amount of the wheel, and the like.

### <Target>

The target calculation unit 141 calculates information indicating a target existing at the periphery of the subject vehicle. The target calculation unit 141 recognizes a target including a moving object such as other vehicle, a bicycle, and a pedestrian, and a stationary object (also referred to as a feature) such as a guardrail or a sign based on signals input from the external sensor group 1 such as the camera 1a, a LiDAR, and a radar, and outputs target information indicating the recognized target.

### <Drivable Region>

The classification unit 142 performs predetermined segmentation processing on a camera image serving as exterior environment information around the subject vehicle to classify a region of the image into a drivable region and a non-drivable region. The drivable region is a road surface region in an advancing direction of a road (driving path), and the non-drivable region is a region other than the drivable region.

### <Virtual Curvature>

The curvature estimation unit 143 calculates a virtual curvature serving as an estimated value of the curvature of the driving path based on the driving state of the subject vehicle including the steering angle information detected by the steering angle sensor 2a, the vehicle speed information detected by the vehicle speed sensor 2d, and the like.

In the embodiment, the virtual curvature calculated by the curvature estimation unit 143 is referred to as an estimated value. In addition, a virtual curvature in a case where the estimated value is updated by the curvature update unit 144C at the time of determination processing by the determination unit 144 described later is referred to as an updated value.

### <Collision Determination>

The determination unit 144 includes a coordinate conversion unit 144A, a collision determination unit 144B, and a curvature update unit 144C.

The coordinate conversion unit 144A performs coordinate conversion from the bird's-eye view coordinate system to the perspective view coordinate system. Specifically, a bird's-eye view coordinate system of a bird's-eye view of a driving path or the like viewed from above is converted into a perspective view coordinate system corresponding to a camera image.

In the embodiment, the deviation of the virtual future path from the drivable region to the non-drivable region is called collision. The collision determination unit 144B compares the drivable region included in the camera image serving as the exterior environment information with a virtual future path calculated by a virtual path calculation unit 146 to be described later, and determines whether or not the virtual future path is included in the drivable region (in other words, whether or not the virtual future path collides with the non-drivable region). That the virtual future path is included in the drivable region means that the estimated value of the curvature of the driving path is appropriate. Conversely, that the virtual future path collides with the non-drivable region means that the virtual future path deviates from the drivable region to the non-drivable region, in other words, the estimated value of the curvature of the driving path is inappropriate.

The curvature update unit 144C updates the estimated value (initial curvature) when the virtual future path deviates from the drivable region to the non-drivable region. The update of the curvature may be referred to as correction.

### <Previous Plan Update>

In order to efficiently search for the curvature (in other words, suppress the number of times of updating the curvature), the previous plan update unit 145 outputs information on the curvature (estimated value or updated value) adopted at the time of the previous curvature search to the curvature estimation unit 143 and the curvature update unit 144C. The information of the curvature adopted at the time of the previous curvature search is temporarily saved in the previous curvature holding unit 121 in the memory unit 12.

As a result, the curvature estimation unit 143 can calculate the virtual curvature based on the steering angle information detected by the steering angle sensor 2a and the curvature at the time of the previous curvature search. In addition, the curvature update unit 144C can update the virtual curvature using the curvature adopted at the time of the previous curvature search.

### <Virtual Path>

The virtual path calculation unit 146 calculates a virtual future path as an estimated value of a path on which the subject vehicle advances in the future (referred to as a future path) based on the latest virtual curvature. Every time the curvature estimation unit 143 calculates the estimated value of the virtual curvature or the curvature update unit 144C updates the virtual curvature, the virtual path calculation unit 146 newly calculates the virtual future path based on the estimated value or the updated value of the virtual curvature and the virtual future path calculated in the past.

### <Future Path>

The future path setting unit 151 sets the virtual future path as a future path of the subject vehicle (which may also be referred to as a subject vehicle future path).

### <Speed Planning>

The speed planning unit 152 determines the driving speed in parallel with the determination of the steering angle by a steering angle planning unit (not illustrated) so as to follow the subject vehicle future path serving as the target route and so as not to generate acceleration in the lateral direction of equal to or greater than a prescribed value.

### <Driving Control>

The driving control unit 16 outputs instruction information to each actuator AC so that the subject vehicle drives along the subject vehicle future path at the determined speed (hereinafter referred to as a planned speed) and steering angle (hereinafter referred to as a planned steering angle).

### <Flow of Search for Curvature>

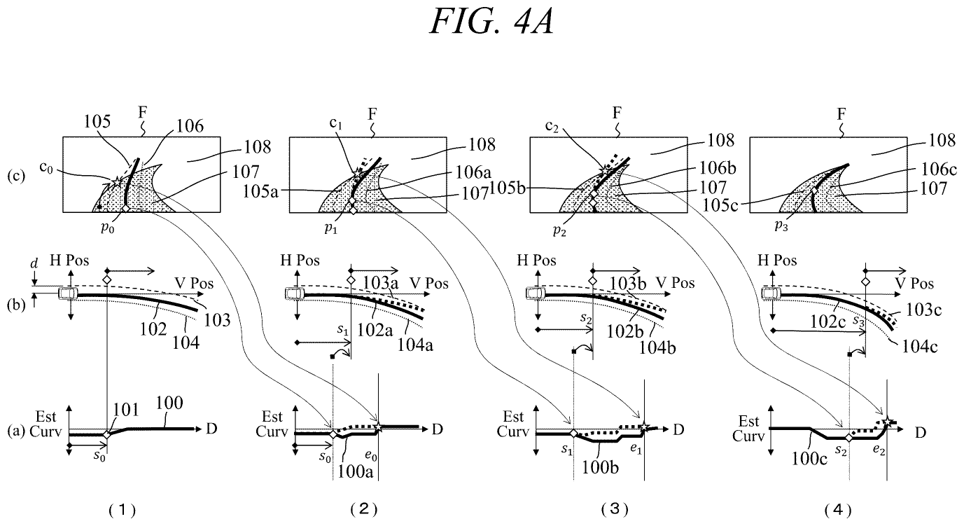

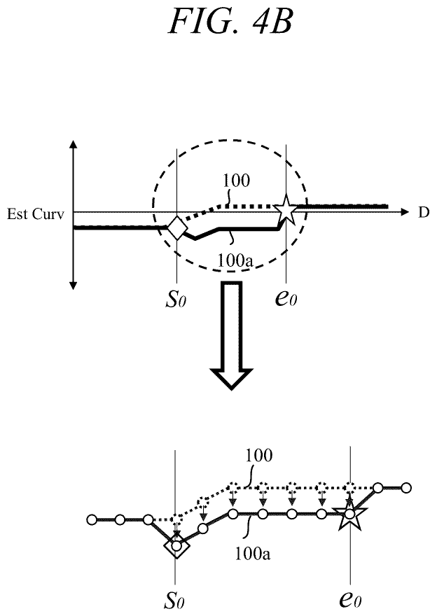

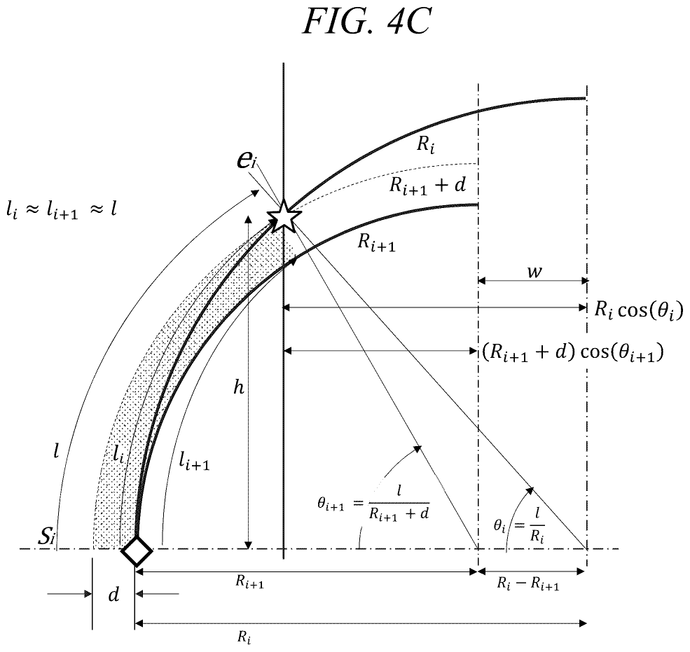

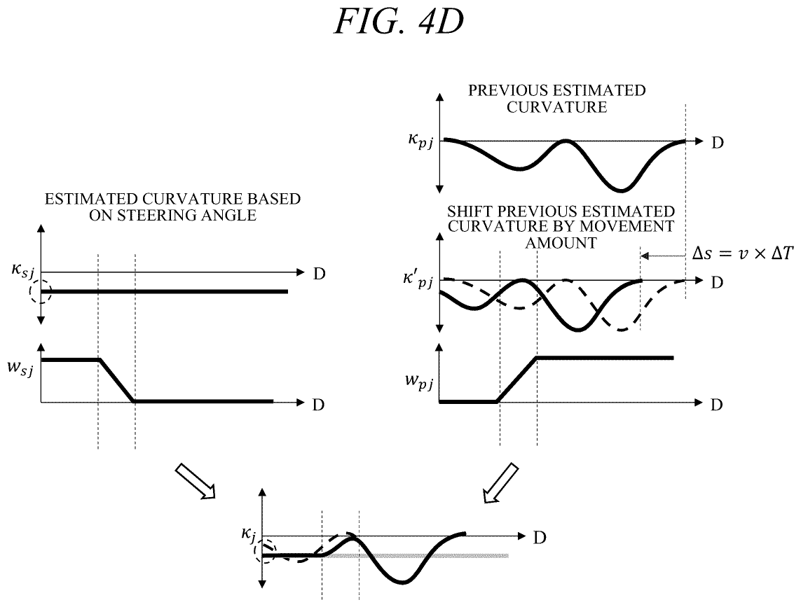

A flow of processing of searching for the curvature of the driving path so that the virtual future path after the coordinate conversion falls within the drivable region will be described with reference to FIG. 4A.

In the embodiment, the curvature search processing is divided into a first phase to a third phase. (a) In the first phase, the curvature of the driving path is estimated or updated. Subsequently, in the second phase (b), a virtual future path of the subject vehicle corresponding to the curvature in the bird's-eye view coordinates is calculated. Furthermore, in the third phase (c), the virtual future path calculated in the bird's-eye view coordinates is coordinate converted and superimposed on the camera image shown in the perspective view coordinates.

Furthermore, in the embodiment, the first phase (a) to the third phase (c) are set as one set processing, and the set processing is repeated over a plurality of times until the virtual future path after the coordinate conversion falls within the drivable region in the camera image. FIG. 4A illustrates a case where the set processing is repeated four times. The number in parentheses in the figure indicates the number of times the set processing has been executed.

### (a) First Phase

In FIG. 4A, when a camera image of a new frame is acquired by the camera 1a, the processing unit 11 causes the classification unit 142 to classify the region of the camera image into the drivable region and the non-drivable region described above.

In parallel with the classification of the regions of the camera image by the classification unit 142, the processing unit 11 performs the processing of the first phase in the first set processing. In the processing of the first phase, the processing unit 11 determines a search start position 101 at a position advanced by a distance s0 in the advancing direction (rightward in the drawing) of the subject vehicle. For example, a position corresponding to point p0 corresponding to the lowermost portion of the screen of the camera image F when converted into the perspective view coordinates later is set as the search start position 101. The vertical axis “Est Curv” of the graph represents an estimated curvature, i.e., the virtual curvature estimated by the curvature estimation unit 143. The horizontal axis “D” represents a travel distance in the advancing direction of the subject vehicle.

The processing unit 11 further estimates, by the curvature estimation unit 143, the virtual curvature 100 for the camera image of the current frame based on the steering angle information detected by the steering angle sensor 2a and the curvature updated at the time of searching for the previous curvature for the camera image of the previous frame.

### (b) Second Phase

After estimating the virtual curvature 100, the processing unit 11 performs the processing of the second phase in the first set processing in the bird's-eye view coordinates. In the processing of the second phase, the virtual path calculation unit 146 of the processing unit 11 calculates the virtual future path 102 serving as an estimated value of the future path on which the subject vehicle advances in the future based on the virtual curvature 100. The virtual future path 102 may be referred to as a predicted driving position. The vertical axis “H Pos” of the graph represents the predicted driving position in the lane width direction. The horizontal axis “V Pos” represents the predicted driving position in the advancing direction (the advancing direction at a time when a camera image F is captured).

The processing unit 11 further generates, by the determination unit 144, a first detection line 103 having the same shape as the virtual future path 102 on the left side in the advancing direction of the subject vehicle with respect to the virtual future path 102 at a predetermined detection line interval d, and generates a second detection line 104 having the same shape as the virtual future path 102 on the right side in the advancing direction with respect to the virtual future path 102 at the detection line interval d. The detection line interval d may be, for example, a vehicle body width or a value obtained by adding a margin to the vehicle body width of the subject vehicle.

### (c) Third Phase

When generating the virtual future path 102, the first detection line 103, and the second detection line 104, the processing unit 11 converts the processing of the third phase in the first set processing from the bird's-eye view coordinate system to the perspective view coordinate system and performs the processing.

The processing unit 11 performs coordinate conversion from the bird's-eye view coordinate system to the perspective view coordinate system for each of the virtual future path 102, the first detection line 103, and the second detection line 104 by the coordinate conversion unit 144A of the determination unit 144, and generates the virtual future path, the first detection line, and the second detection line in the perspective view coordinates.

In the first set processing of FIG. 4A, the camera image F of one frame indicated by the perspective view coordinates is classified into the drivable region 107 and the non-drivable region 108 by the classification unit 142.

The processing unit 11 superimposes the virtual future path (thick line), the first detection line 105, and the second detection line 106 after the coordinate conversion on the camera image F.

The collision determination unit 144B compares the drivable region 107 included in the camera image F with the virtual future path (thick line) in the perspective coordinates, and determines whether or not the virtual future path (thick line) is included in the drivable region 107 (in other words, whether or not the virtual future path (thick line) collides with the non-drivable region 108).

As an example, the collision determination unit 144B checks whether or not the first detection line 105 and the second detection line 106 are included in the drivable region 107 along the tracks of the first detection line 105 and the second detection line 106 sequentially from the position of point p0 corresponding to the search start position 101 in the advancing direction (upward direction). At this time, in a case where at least one of the first detection line 105 and the second detection line 106 has changed from the drivable region 107 to the non-drivable region 108 (in other words, in a case where at least one of the first detection line 105 and the second detection line 106 has collided with the non-drivable region 108), it can be assumed that the curvature of the driving path has not been appropriately estimated. On the other hand, in a case where both the first detection line 105 and the second detection line 106 are included in the drivable region 107 (in other words, in a case where the first detection line 105 and the second detection line 106 do not collide with the non-drivable region 108), it can be assumed that the curvature of the driving path has been appropriately estimated.

Therefore, in a case where at least one of the first detection line 105 and the second detection line 106 collides with the non-drivable region 108, the determination unit 144 updates the curvature by the curvature update unit 144C.

Specifically, when the first detection line 105 collides with the non-drivable region 108 at the position of point c0 in the camera image F, the curvature update unit 144C calculates the distance e0 corresponding to point c0 in the bird's-eye view coordinates. Then, the curvature update unit 144C updates the curvature of the section from point s0 to point e0 in the negative direction so as to be a curvature that bends further to the right (to the right in the advancing direction). The amount of update will be described later.

As another example (not illustrated), when the second detection line 106 collides with the non-drivable region 108 in the camera image F, the curvature update unit 144C calculates a distance e0 corresponding to the collision point in the bird's-eye view coordinates. Then, the curvature update unit 144C updates the curvature of the section from point s0 to point e0 in the positive direction so as to be a curvature that bends further to the left (to the left in the advancing direction). The amount of update will be described later.

When the curvature update unit 144C updates the curvature, the processing unit 11 performs the second set processing.

### (a) First Phase

The processing unit 11 performs the processing of the first phase in the second set processing.

In the processing of the first phase, the processing unit 11 causes the curvature update unit 144C to update the section from point s0 to point e0 in the virtual curvature 100 estimated in the first set processing to the virtual curvature 100a. The amount of update will be described later.

### (b) Second Phase

After updating to the virtual curvature 100a, the processing unit 11 performs the processing of the second phase in the second set processing in the bird's-eye view coordinates. The processing unit 11 starts the search from a position of point s1 advanced by a predetermined distance in the advancing direction (rightward in the drawing) of the subject vehicle from point s0 where the search is started at the time of the first set processing. The reason the position where the search is started in the second set processing is advanced from point s0 where the search is started in the first set processing is because the section in which the first detection line 105 and the second detection line 106 do not collide with the non-drivable region 108 does not need to be included as the search target at the time of the second set processing.

Note that the amount by which the search start position is moved from point s0 to point s1 may be, for example, an amount by which the movement amount from the corresponding point p0 to point p1 in the camera image F when converted into the perspective coordinates corresponds to at least one pixel. In other words, the movement amount from point p0 to point p1 may be larger than the amount corresponding to one pixel.

In the processing of the second phase, the virtual path calculation unit 146 of the processing unit 11 calculates a virtual future path 102a serving as an estimated value of a future path on which the subject vehicle advances in the future based on the updated virtual curvature 100a.

The processing unit 11 further generates, by the determination unit 144, a first detection line 103a having the same shape as the virtual future path 102a on the left side in the advancing direction of the subject vehicle with respect to the virtual future path 102a at a predetermined detection line interval d, and generates a second detection line 104a having the same shape as the virtual future path 102a on the right side in the advancing direction with respect to the virtual future path 102a at a predetermined detection line interval d.

### (c) Third Phase

When generating the virtual future path 102a, the first detection line 103a, and the second detection line 104a, the processing unit 11 converts the processing of the third phase in the second set processing from the bird's-eye view coordinate system to the perspective view coordinate system and performs the processing.

The processing unit 11 performs coordinate conversion from the bird's-eye view coordinate system to the perspective view coordinate system for each of the virtual future path 102a, the first detection line 103a, and the second detection line 104a by the coordinate conversion unit 144A of the determination unit 144, and generates the virtual future path, the first detection line, and the second detection line in the perspective view coordinates.

In the second set processing of FIG. 4A, similarly to the first set processing, the camera image F of one frame indicated by the perspective view coordinates is classified into the drivable region 107 and the non-drivable region 108.

The processing unit 11 superimposes the virtual future path (thick line), the first detection line 105a, and the second detection line 106a after the coordinate conversion on the camera image F.

Similarly to the first set processing, the collision determination unit 144B compares the drivable region 107 included in the camera image F with the virtual future path (thick line) in the perspective coordinates, and determines whether or not the virtual future path (thick line) is included in the drivable region 107 (in other words, whether or not the virtual future path (thick line) collides with the non-drivable region 108).

As an example, the collision determination unit 144B checks whether or not the first detection line 105a and the second detection line 106a are included in the drivable region 107 along the tracks of the first detection line 105a and the second detection line 106a sequentially from the position of point p1 in the advancing direction (upward). The procedure is similar to that of the first set processing. In a case where at least one of the first detection line 105a and the second detection line 106a collides with the non-drivable region 108, the determination unit 144 causes the curvature update unit 144C to update the curvature again.

Specifically, when the first detection line 105a collides with the non-drivable region 108 at the position of point cl in the camera image F, the curvature update unit 144C calculates the distance e1 corresponding to point cl in the bird's-eye view coordinates. Then, the curvature update unit 144C updates the curvature of the section from point s1 to point e1 in the negative direction so as to be a curvature that bends further to the right (to the right in the advancing direction). The amount of update will be described later.

As another example (not illustrated), when the second detection line 106a collides with the non-drivable region 108 in the camera image F, the curvature update unit 144C calculates a distance e1 corresponding to the collision point in the bird's-eye view coordinates. Then, the curvature update unit 144C updates the curvature of the section from point s1 to point e1 in the positive direction so as to be a curvature that bends further to the left (to the left in the advancing direction). The amount of update will be described later.

The third set processing in FIG. 4A is similar to the second set processing described above, and thus the description thereof will be omitted.

When the curvature update unit 144C updates the curvature in the third set processing, the processing unit 11 performs the fourth set processing.

### (a) First Phase

The processing unit 11 performs the processing of the first phase in the fourth set processing.

In the processing of the first phase, the processing unit 11 causes the curvature update unit 144C to update the section from point s2 to point e2 in the virtual curvature 100b estimated in the third set processing to the virtual curvature 100c. The amount of update will be described later.

### (b) Second Phase

After updating to the virtual curvature 100c, the processing unit 11 performs the processing of the second phase in the fourth set processing in the bird's-eye view coordinates. The processing unit 11 starts the search from a position of point s3 advanced by a predetermined distance in the advancing direction (rightward in the drawing) of the subject vehicle from point s2 where the search is started at the time of the third set processing. The reason the position where the search is started in the fourth set processing is advanced from point s2 where the search is started in the third set processing is because the section in which the first detection line 105b and the second detection line 106b do not collide with the non-drivable region 108 does not need to be included as the search target at the time of the fourth set processing.

Note that the amount by which the search start position is moved from point s2 to point s3 may be, for example, an amount by which the movement amount from the corresponding point p2 to point p3 in the camera image F when converted into the perspective coordinates corresponds to at least one pixel. In other words, the movement amount from point p2 to point p3 may be larger than the amount corresponding to one pixel.

In the processing of the second phase, the virtual path calculation unit 146 of the processing unit 11 calculates a virtual future path 102c serving as an estimated value of a future path on which the subject vehicle advances in the future based on the updated virtual curvature 100c.

The processing unit 11 further generates, by the determination unit 144, a first detection line 103c having the same shape as the virtual future path 102c on the left side in the advancing direction of the subject vehicle with respect to the virtual future path 102c at a predetermined detection line interval d, and generates a second detection line 104c having the same shape as the virtual future path 102c on the right side in the advancing direction with respect to the virtual future path 102c at a predetermined detection line interval d.

### (c) Third Phase

When generating the virtual future path 102c, the first detection line 103c, and the second detection line 104c, the processing unit 11 converts the processing of the third phase in the fourth set processing from the bird's-eye view coordinate system to the perspective view coordinate system and performs the processing.

The processing unit 11 performs coordinate conversion from the bird's-eye view coordinate system to the perspective view coordinate system for each of the virtual future path 102c, the first detection line 103c, and the second detection line 104c by the coordinate conversion unit 144A of the determination unit 144, and generates the virtual future path, the first detection line, and the second detection line in the perspective view coordinates.

The fourth set processing of FIG. 4A is similar to the previously described set processing in that the camera image F of one frame indicated by the perspective view coordinates is classified into the drivable region 107 and the non-drivable region 108, which is similar to the set processing described above.

The processing unit 11 superimposes the virtual future path (thick line), the first detection line 105c, and the second detection line 106c after the coordinate conversion on the camera image F.

Similarly to the previously described set processing, the collision determination unit 144B compares the drivable region 107 included in the camera image F with the virtual future path (thick line), and determines whether or not the virtual future path (thick line) is included in the drivable region 107 (in other words, whether or not the virtual future path (thick line) collides with the non-drivable region 108).

As an example, in a case where both the first detection line 105c and the second detection line 106c do not collide with the non-drivable region 108, the determination unit 144 ends the set processing. When the set processing is ended, the future path setting unit 151 sets the virtual future path as the subject vehicle future path.

The processing unit 11 performs the set processing described above on the camera image of the same frame in accordance with the frame rate at which the camera 1a acquires the camera image. More specifically, when a camera image for one frame is acquired by the camera 1a, the set processing is repeated a plurality of times until a camera image of the next frame is acquired. An upper limit (e.g., 10 times) may be set to the number of repetitions of the set processing.

As in the fourth set processing described above, when a first detection line 105x and a second detection line 106x after the coordinate conversion fall within the drivable region in the camera image before the number of repetitions of the set processing reaches the upper limit (10 times) (in other words, when both the first detection line 105x and the second detection line 106x do not collide with the non-drivable region 108), the set processing may be ended at that time.

In addition, when the first detection line 105 and the second detection line 106 after the coordinate conversion fall within the drivable region in the camera image by the first set processing, the set processing may be ended without being repeated.

Note that in a case where the driving path is a terminal end of the road like a T-junction, or in a case where there is a preceding vehicle in front of the subject vehicle on the driving path, there is a possibility that the first detection line 105 and the second detection line 106 do not fall within the drivable region in the process of searching for the curvature. In this case, the search for the curvature may be stopped, and the planned speed may be set to 0 with respect to the search position. In this way, it is possible to prevent a vehicle from rushing into a region where driving is not possible.

### <Update Amount>

FIG. 4B is a schematic diagram illustrating update of the curvature. FIG. 4B is an enlarged view of a portion corresponding to (a) the first phase of the second set processing in FIG. 4A. The lower part of FIG. 4B is a view in which the upper part of FIG. 4B is further enlarged.

As described above, the curvature update unit 144C of the processing unit 11 updates the section (indicated by the broken line) from point s0 to point e0 in the virtual curvature 100 estimated in the first set processing to the virtual curvature 100a (indicated by the solid line). FIG. 4B illustrates a case where the curvature update unit 144C updates the curvature of the section from point s0 to point e0 in the negative direction so as to be a curvature that bends to the right (to the right in the advancing direction) with respect to the virtual curvature 100.

### Calculation Example of Update Amount

FIG. 4C is a schematic diagram illustrating a relationship among the virtual curvature, the curvature radius, and the position before and after the update. It is assumed that point si is already at the center of the road from point si to point ei serving as the section in which the virtual curvature is to be updated. At that time, when the virtual curvature of the section before the update is κi, it is assumed that the vehicle collided with the non-drivable region at the point of position 1 in the advancing direction (in other words, the vehicle collided with the left end of the drivable region). At this time, how to set the virtual curvature κi+1 after the update is obtained. In a case where it is assumed that the drivable region is continued while always being separated from the virtual future path after the update of the virtual curvature by the detection line interval d, the relationship among the virtual curvature κi before the update, the curvature radius Ri, and the position 1 is as illustrated in FIG. 4C. The following simultaneous equations are obtained from the relationship in FIG. 4C.

### [Mathematical Formula 1]

The processing unit 11 obtains a curvature radius Ri+1 (updated curvature radius) when the curvature radius Ri, the position 1, and the detection line interval d are given by the Newton method or the like using the above equations (1) to (4). The virtual curvature κi+1 after the update can be obtained as a reciprocal of the curvature radius Ri+1.

### <Calculation of Virtual Curvature>

The virtual curvature (estimated value) calculated by the curvature estimation unit 143 will be described with reference to FIG. 4D.

As described above, the curvature estimation unit 143 calculates the virtual curvature κsj based on the steering angle information detected by the steering angle sensor 2a and the driving state (as an example, the current vehicle speed) of the subject vehicle. Since the first calculated value is an initial search value when the virtual curvature is obtained, it may be referred to as an initial value of the virtual curvature.

In addition, the curvature estimation unit 143 may use the information from the previous plan update unit 145 to input the virtual curvature κsj, the virtual curvature κpi obtained by the previous curvature search, and the current vehicle speed v detected by the vehicle speed sensor 2d, and obtain the virtual curvature κj by the following equation (5).

$$κ j = Wsj \times κ sj + Wpj \times κ ’ pj . \qquad ( 5 )$$

However, the weight Wsj is a weight value that changes according to the distance s from the subject vehicle with respect to the estimated curvature obtained from the steering angle, and approaches 1 as the distance becomes closer to the subject vehicle, and approaches 0 as the distance becomes farther from the subject vehicle.

In addition, similarly to the weight Wsj, the weight Wpj is a weight value that changes according to the distance s from the subject vehicle with respect to the estimated curvature obtained from the steering angle, and approaches 0 as the distance becomes closer to the subject vehicle, and approaches 1 as the distance becomes farther from the subject vehicle. The sum of the weight Wsj and the weight Wpj is always 1 regardless of the distance s.

Furthermore, the virtual curvature κ′pj is a virtual curvature obtained by shifting the virtual curvature κpj obtained in the previous search by a distance Δs by which the subject vehicle has advanced in a processing cycle ΔT (in the embodiment, corresponding to the frame interval at which the camera 1a acquires the camera image) from the previous search to the current search.

According to the above equation (5), since the current search is performed using the virtual curvature κpj obtained in the previous search, the number of iterations (in other words, the number of repetitions of the set processing) can be reduced as compared with the case where the previous virtual curvature κpj is not used, and the load of the arithmetic processing for the search can be reduced. The distance Δs is obtained by the following equation (6).

$$Δ s = v \times Δ T \qquad ( 6 )$$

### <Description of Flowchart>

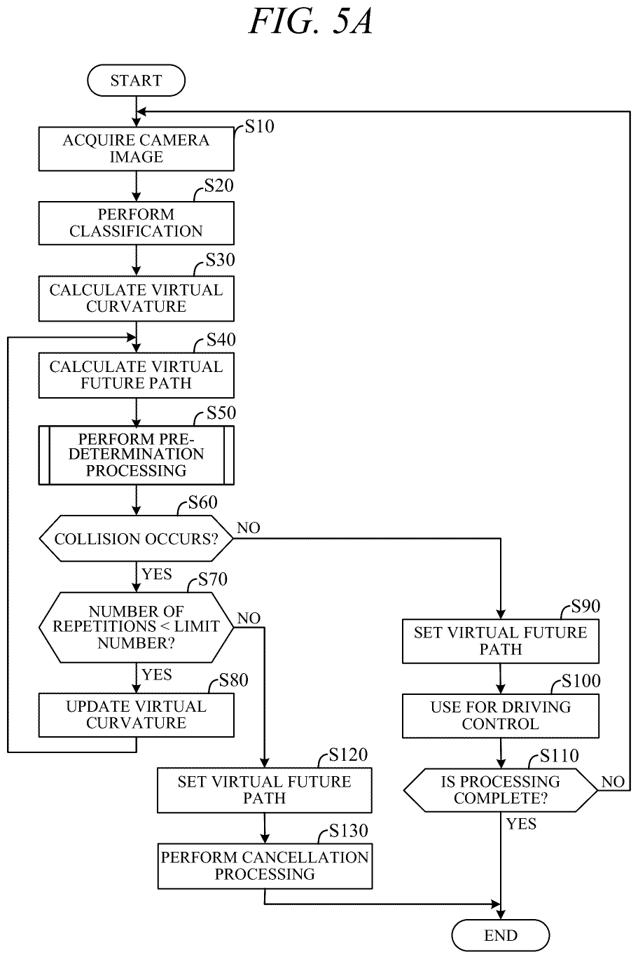

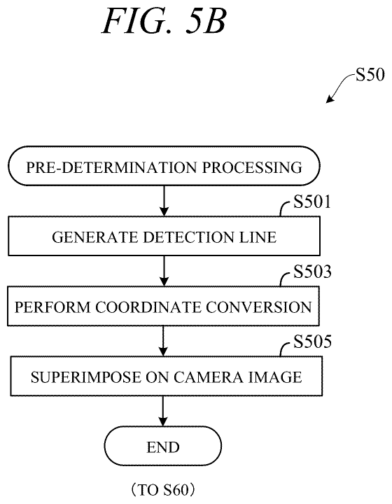

FIG. 5A is a flowchart illustrating an example of arithmetic processing executed by the processing unit 11 of the controller 10 in FIG. 2 according to a program defined in advance. The processing illustrated in the flowchart is repeatedly executed, for example, while the subject vehicle is driving in the self-drive mode. Furthermore, the processing may be executed when the subject vehicle is driving in the manual drive mode and, for example, the lane keeping capability, which is one of the driving assistance capabilities, is enabled, that is, when the subject vehicle is driving in the lane keeping mode.

In step S10, the processing unit 11 acquires the camera image from the camera 1a in units of frames, and proceeds to step S20.

In step S20, the processing unit 11 causes the classification unit 142 to classify the region of the camera image into the drivable region 107 and the non-drivable region 108, and proceeds to step S30.

In step S30, the processing unit 11 causes the curvature estimation unit 143 to calculate a virtual curvature as an estimated value of the curvature of the driving path, and proceeds to step S40.

In step S40, the processing unit 11 causes the virtual path calculation unit 146 to calculate a virtual future path as an estimated value of a future path on which the subject vehicle advances in the future, and proceeds to step S50. The processing of step S40 corresponds to the processing of (b) the second phase in the set processing described above.

In step S50, the processing unit 11 performs pre-determination processing and proceeds to step S60. Details of the pre-determination processing will be described later with reference to the flowchart illustrated in FIG. 5B. The processing of step S50 corresponds to the processing of (b) the second phase and the pre-stage portion of the processing of (c) the third phase in the set processing described above.

In step S60, the processing unit 11 determines whether or not the virtual future path collides with the non-drivable region 108 by the collision determination unit 144B. For example, when it is determined that at least one of the first detection line 105 and the second detection line 106 collides with the non-drivable region 108, the processing unit 11 makes an affirmative determination in step S60 and proceeds to step S70, and when it is determined that both the first detection line 105 and the second detection line 106 do not collide with the non-drivable region 108, the processing unit makes a negative determination in step S60 and proceeds to step S90.

The processing of step S60 corresponds to the post-stage portion of the processing of (c) the third phase in the set processing described above.

In step S70, the processing unit 11 determines whether or not the number of repetitions of the set processing is less than the limit number. The processing unit 11 makes an affirmative determination in step S70 when the number of repetitions is less than the limit number and proceeds to step S80, and makes a negative determination in step S70 when the number of repetitions is not less than the limit number (in other words, when the upper limit value has been reached) and proceeds to step S120.

In step S80, the processing unit 11 updates the virtual curvature by the curvature update unit 144C, and returns to step S40. The reason for returning to step S40 is to repeat the set processing.

The processing of step S80 corresponds to the processing of (a) the first phase in the second and subsequent set processing described above.

In step S90 that is reached when a negative determination is made in step S60, the processing unit 11 sets the virtual future path as the subject vehicle future path by the future path setting unit 151, and proceeds to step S100.

In step S100, the processing unit 11 sends a command to the driving control unit 16 to use the planned speed and the planned steering angle based on the subject vehicle future path for driving control, and proceeds to step S110.

In step S110, the processing unit 11 determines whether to end the processing. For example, when the self-drive mode is canceled, the processing unit 11 makes an affirmative determination in step S110 and ends the processing according to FIG. 5A. For example, when the self-drive mode is continued, the processing unit 11 makes a negative determination in step S110, returns to step S10, and repeats the above-described processing.

In step S120 that is reached when a negative determination is made in step S70, the processing unit 11 sets the virtual future path at that time point as the subject vehicle future path by the future path setting unit 151, and proceeds to step S130.

In step S130, the processing unit 11 performs predetermined cancellation processing and ends the processing according to FIG. 5A. In the cancellation processing, as an example, the search for the curvature is canceled, and the planned speed is set to zero with respect to the search position. In this way, it is possible to prevent a vehicle from rushing into a region where driving is not possible.

### <Pre-determination Processing>

Details of the pre-determination processing will be described with reference to the flowchart illustrated in FIG. 5B. FIG. 5B is a flowchart illustrating an example of the pre-determination processing of step S50 executed by the processing unit 11.

In step S501, the processing unit 11 generates the first detection line 103 and the second detection line 104 having the same shape as the virtual future path by the determination unit 144, and proceeds to step S503.

In step S503, the processing unit 11 causes the coordinate conversion unit 144A of the determination unit 144 to perform coordinate conversion from the bird's-eye view coordinate system to the perspective view coordinate system for each of the virtual future path, the first detection line, and the second detection line and generate the virtual future path, the first detection line, and the second detection line in the perspective view coordinates, and proceeds to step S505.

In step S505, when the virtual future path, the first detection line, and the second detection line after the coordinate conversion are superimposed on the camera image F, the processing unit 11 ends the processing in FIG. 5B and proceeds to step S60 in FIG. 5A.

According to the above-described embodiments heretofore, the following operation and effects are obtained.

(1) A vehicle control apparatus 200 includes: a camera 1a serving as an exterior environment information acquisition unit for acquiring exterior environment information around a subject vehicle including a driving path as a camera image F, a classification unit 142 for classifying a region of the camera image F into a drivable region 107 and a non-drivable region 108 by predetermined segmentation processing, a curvature estimation unit 143 for calculating a virtual curvature as an estimated value of curvature of the driving path based on a driving state including a steering angle of the subject vehicle, a virtual path calculation unit 146 for calculating a virtual future path 102 serving as an estimated value of a future path of the subject vehicle in a bird's-eye view coordinate system based on the virtual curvature, a determination unit 144 for comparing the camera image F with the virtual future path 102 and determining whether or not the virtual future path 102 is included in the drivable region 107, a future path setting unit 151 for setting a virtual future path 102 as a subject vehicle future path, and a driving control unit 16 for performing driving control on the subject vehicle based on the subject vehicle future path, in which the determination unit 144 converts the virtual future path 102 calculated by the virtual path calculation unit 146 from a bird's-eye view coordinate system to a perspective view coordinate system of a camera image F, and superimposes the virtual future path 102 on the camera image F to determine whether or not the virtual future path 102 is included in a drivable region 107.

With this configuration, the virtual future path 102 calculated in the bird's-eye view coordinate system is coordinate-converted from the bird's-eye view coordinate system to the perspective view coordinate system and then superimposed on the perspective view coordinate system of the camera image F captured by the camera 1a, whereby whether or not the virtual future path 102 is included in the drivable region 107 can be appropriately determined. In particular, it is possible to make a determination with higher accuracy for a driving path having a non-constant curvature or a distant driving path far away from the subject vehicle. Then, by performing driving control based on the virtual future path 102 appropriately calculated with high accuracy as described above, for example, even in a case of driving for the first time on a road that is not stored as high-precision map information in the memory unit 12, the subject vehicle can be appropriately driving controlled.

(2) In the vehicle control apparatus 200, when determining that a part of the virtual future path 102 is not included in the drivable region 107, the determination unit 144 updates the virtual curvature based on the position where the virtual future path 102 deviates from the drivable region 107 to the non-drivable region 108, and determines again whether the virtual future path 102a calculated again by the virtual path calculation unit 146 based on the updated virtual curvature is included in the drivable region 107.

With this configuration, it is possible to reliably generate the virtual future path 102a on which the subject vehicle can drive.

(3) In the vehicle control apparatus 200, the determination unit 144 generates the first detection line 103 having the same shape as the virtual future path 102 on the left side in the advancing direction of the subject vehicle with respect to the virtual future path 102 at a predetermined detection line interval d, generates the second detection line 104 having the same shape as the virtual future path 102 on the right side in the advancing direction with respect to the virtual future path 102 at a predetermined detection line interval d, performs collision determination with the non-drivable region 108 in the advancing direction from the position corresponding to a predetermined reference point p0 with respect to each of the first detection line 103 (105) and the second detection line 104 (106), updates the virtual curvature to increase to the right side when the first detection line 103 (105) collides with the non-drivable region 108, and updates the virtual curvature to increase to the left side when the second detection line 104 (106) collides with the non-drivable region 108.

With this configuration, in a case where the collision is determined with respect to the non-drivable region 108, it is possible to easily determine the direction of updating the virtual future path 102 (increase virtual curvature to the right side or left side).

(4) In the vehicle control apparatus 200, in a case where any of the first detection line 103 (105) and the second detection line 104 (106) collides with the non-drivable region 108, the determination unit 144 generates again the first detection line 103a and the second detection line 104a on the left and right of the virtual future path 102a based on the updated virtual curvature, moves the positions corresponding to the respective reference points p0 in the advancing direction, and performs collision determination with the non-drivable region 108 in the advancing direction from the positions corresponding to the reference points p1 after the movement with respect to the first detection line 103a (105a) and the second detection line 104a (106a) generated again. The movement amount from the reference point p0 to the reference point p1 in the camera image F is an amount corresponding to at least one pixel.

With this configuration, it is possible to suppress an excessive change in curvature with respect to the virtual future path 102a to be updated next by searching for the curvature while gradually offsetting the position to start the collision determination.

(5) In the vehicle control apparatus 200, in a case where the number of times of updating the virtual curvature reaches a predetermined upper limit number of times, the future path setting unit 151 sets the virtual future path 102 and the like as a subject vehicle future path, and the driving control unit 16 recognizes that the driving path is a dead end and performs predetermined driving control.

With this configuration, for example, the search for the curvature can be terminated in a situation where the virtual future path cannot be generated even if the virtual curvature is updated many times, such as a dead end.

(6) In the vehicle control apparatus 200, when the reference points of the first detection line 105 and the like and the second detection line 106 and the like each reach the depth distance (corresponding to the vanishing point) corresponding to the terminal end of the virtual future path 102 and the like, and the number of times of updates is smaller than the upper limit number of times, the determination unit 144 returns the reference points to the positions corresponding to points p0 serving as the initial positions, and repeats the determination as to whether or not the virtual future path 102 and the like based on the updated virtual curvature are included in the drivable region 107.

With this configuration, for example, by changing the calculation condition and searching for the curvature again, it is possible to lead to more appropriate calculation of the virtual future path.

(7) In the vehicle control apparatus 200, the virtual path calculation unit 146 calculates the subject vehicle future path at predetermined time intervals, and calculates the virtual future path based on the virtual curvature and the subject vehicle future path calculated in the past.

With such a configuration, by reflecting the information of the virtual future path calculated last time, it is possible to suppress the number of repetitions of the above-described set processing of updating the virtual curvature→calculating the virtual future path based on the updated virtual curvature→performing collision determination on the non-drivable region.

(8) The vehicle control apparatus 200 further includes a speed planning unit 152 for setting a vehicle speed upper limit of the subject vehicle based on the subject vehicle future path and the allowable acceleration of the subject vehicle and generating a speed plan of the subject vehicle based on the vehicle speed upper limit, in which the driving control unit 16 performs driving control based on the speed plan.

With this configuration, it is possible to correctly recognize the curvature or the like of the curved road included in the subject vehicle future path and then make an appropriate speed plan so as not to cause uncomfortable acceleration to the occupant.

The above embodiments may be modified into various modes. Hereinafter, modified examples will be described.

In the above embodiment, the example has been described in which the detection line interval d between the virtual future path 102 and the first detection line 103 and the detection line interval d between the virtual future path 102 and the second detection line 104 are set to the vehicle body width of the subject vehicle. Alternatively, a value different from the vehicle body width may be set.

For example, in the above-described vehicle control apparatus 200, the determination unit 144 may set the detection line interval d based on at least one of the motion characteristic of the subject vehicle, the width of the drivable region 107, the first information regarding the driving characteristic learned by the subject vehicle, and the second information regarding the driving characteristic set by the occupant of the subject vehicle.

With this configuration, by changing the interval between the first detection line 103 and the second detection line 104 according to the situation, the virtual curvature is updated to a virtual curvature more suitable for the occupant, and the virtual future path 102a can be generated based on the updated virtual curvature.

Instead of performing the collision determination between the first detection line 103 and the second detection line 104 and the non-drivable region 108, the collision with the non-drivable region 108 may be determined as follows.

For example, in the above-described vehicle control apparatus 200, the determination unit 144 may set a detection region including the virtual future path 102 and having a predetermined region width in the left-right direction of the subject vehicle in the advancing direction of the subject vehicle, perform collision determination with the non-drivable region 108 in the advancing direction from a predetermined reference point on the detection region, update the virtual curvature to be large on the right side when the left side of the end portions in the left-right direction of the detection region collides with the non-drivable region 108, and update the virtual curvature to be large on the left side when the right side of the end portions in the left-right direction of the detection region collides with the non-drivable region 108.

Even in such a configuration, similarly to the above-described embodiment, it is possible to easily determine the direction of updating the virtual future path 102 at the time of collision determination with the non-drivable region 108.

The above embodiment can be combined as desired with one or more of the above modifications. The modifications can also be combined with one another.

According to the present invention, it is possible to appropriately perform driving control even on a driving path having a non-constant curvature.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus comprising: an exterior environment information acquisition sensor configured to acquire exterior environment information around a subject vehicle including a driving path as an image; an actuator for driving; and a microprocessor, wherein
the microprocessor is configured to perform:
classifying a region of the image into a drivable region and a non-drivable region by predetermined segmentation processing;
calculating a virtual curvature as an estimated value of curvature of the driving path based on a driving state including a steering angle of the subject vehicle;
calculating, based on the virtual curvature, a virtual future path serving as an estimated value of a future path of the subject vehicle in a bird's-eye view coordinate system;
comparing the exterior environment information with the virtual future path and determining whether or not the virtual future path is included in the drivable region;
setting the virtual future path as the future path of the subject vehicle based on a determination result; and
executing driving control by outputting instruction information to the actuator such that the subject vehicle travels along the future path, wherein
the microprocessor is configured to perform the determining including determining by converting the virtual future path from the bird's-eye view coordinate system to a perspective view coordinate system of the exterior environment information and superimposing the virtual future path on the exterior environment information to determine whether or not the virtual future path is included in the drivable region.

2. The vehicle control apparatus according to claim 1, wherein
the microprocessor is configured to perform the determining including, when it is determined that a part of the virtual future path is not included in the drivable region, updating the virtual curvature based on a position where the virtual future path deviates from the drivable region to the non-drivable region, and determining again whether or not the virtual future path recalculated based on the virtual curvature is included in the drivable region.

3. The vehicle control apparatus according to claim 2, wherein
the microprocessor is configured to perform the determining including:
generating a first detection line having the same shape as the virtual future path on a left side in an advancing direction of the subject vehicle with respect to the virtual future path at a predetermined detection line interval,
generating a second detection line having the same shape as the virtual future path on a right side in the advancing direction with respect to the virtual future path at the predetermined detection line interval,
executing collision determination with the non-drivable region in the advancing direction from a position corresponding to a predetermined reference point with respect to each of the first detection line and the second detection line,
updating the virtual curvature to increase to the right side when the first detection line collides with the non-drivable region, and
updating the virtual curvature to increase to the left side when the second detection line collides with the non-drivable region.

4. The vehicle control apparatus according to claim 3, wherein
the microprocessor is configured to perform the determining including:
when any of the first detection line and the second detection line collides with the non-drivable region, generating again the first detection line and the second detection line on the left and right of the virtual future path based on the updated virtual curvature and moving the positions corresponding to respective reference points in the advancing direction, and
executing the collision determination with the non-drivable region in the advancing direction from the moved reference points with respect to the first detection line generated again and the second detection line generated again.

5. The vehicle control apparatus according to claim 4, wherein
the microprocessor is configured to perform the setting including:
when a number of times of updating the virtual curvature reaches a predetermined upper limit number of times, setting the virtual future path as the future path of the subject vehicle, and
in the driving control, recognizing the driving path as a dead end and executing predetermined driving control.

6. The vehicle control apparatus according to claim 5, wherein
the microprocessor is configured to perform the determining including, when the reference points of the first detection line and the second detection line each reach a depth distance corresponding to a terminal end of the virtual future path and the number of updates is smaller than the upper limit number of times, returning the reference points to initial positions, and repeating the determination as to whether or not the virtual future path based on the updated virtual curvature is included in the drivable region.

7. The vehicle control apparatus according to claim 3, wherein
the microprocessor is configured to perform the determining including setting the predetermined detection line interval based on at least one of a motion characteristic of the subject vehicle, a width of the drivable region, first information regarding a driving characteristic learned by the subject vehicle, and second information regarding a driving characteristic set by an occupant of the subject vehicle.

8. The vehicle control apparatus according to claim 1, wherein
the microprocessor is configured to perform the calculating the virtual future path including calculating the future path of the subject vehicle at predetermined time intervals, and calculating the virtual future path based on the virtual curvature and the future path calculated in the past.

9. The vehicle control apparatus according to claim 1, wherein
the microprocessor is further configured to perform setting a vehicle speed upper limit of the subject vehicle based on the future path and an allowable acceleration of the subject vehicle, and generating a speed plan of the subject vehicle based on the vehicle speed upper limit, and
the microprocessor is configured to perform the executing including executing the driving control based on the speed plan.

10. The vehicle control apparatus according to claim 2, wherein
the microprocessor is further configured to perform the determining including:
setting a detection region including the virtual future path and having a predetermined region width in a left-right direction of the subject vehicle in the advancing direction of the subject vehicle, executing collision determination with the non-drivable region in the advancing direction from a predetermined reference point on the detection region,
updating the virtual curvature to be large on the right side when a left end portion in the left-right direction of the detection region collides with the non-drivable region, and
updating the virtual curvature to be large on the left side when a right end portion in the left-right direction of the detection region collides with the non-drivable region.
